(19) United States
(12) Patent Application Publication
(10) Pub. No.: US 2025/0317225 A1
(43) Pub. Date: Oct. 9, 2025

(54) METHOD, DEVICE AND COMPUTER READABLE MEDIUM FOR COMMUNICATIONS

(71) Applicant: NEC Corporation, Tokyo (JP)

(72) Inventors: Xiaohong ZHANG, Beijing (CN); Gang WANG, Beijing (CN)

(73) Assignee: NEC Corporation, Tokyo (JP)

(21) Appl. No.: 18/866,223

(22) PCT Filed: May 17, 2022
(86) PCT No.: PCT/CN2022/093397

§ 371 Date: Nov. 15, 2024

(51) Int. Cl. H04B 17/345; H04L 5/00; H04L 5/14; H04W 24/10

(52) U.S. Cl. CPC H04B 17/345; H04L 5/0048; H04L 5/14; H04W 24/10

(57) ABSTRACT

Embodiments of the present disclosure relate to methods, devices and computer readable media for management of Cross Link Interference (CLI). According to embodiments of the present disclosure, a first network device measures a CLI level based on at least one CLI-Reference Signal (RS) received from a second network device. In response to the measured CLI level being above a first threshold level, the first network device transmits a first indication to the second network device. The first indication comprises service information associated with the CLI.

### FIELD

Embodiments of the present disclosure generally relate to the field of communication, and in particular, to a method, device and computer readable medium for management of Cross Link Interference (CLI).

### BACKGROUND

With development of the communication technology, network devices have been designed to operate in a full duplex communication mode to improve the communication efficiency: In the full duplex communication mode, the network devices may transmit downlink data transmission and receive uplink data transmission simultaneously. Accordingly, there may be a situation that a network device receives an Uplink (UL) transmission from a terminal device and a Downlink (DL) transmission from another network device simultaneously, if the transmission configurations for these two network devices are not matched. That is, CLI may be occurred if there are different directions of traffics/signals/channels in the same/neighboring cell(s). In order to solving the related technical issues, the example embodiments according to this disclosure provide a mechanism for the CLI management.

### SUMMARY

In general, example embodiments of the present disclosure relate to methods, devices and computer readable media for communication.

In a first aspect, there is provided a method implemented at a first network device operating in a subband full-duplex mode. In the method, the first network device measures a CLI level based on at least one CLI-Reference Signal (RS) received from a second network device. In response to the measured CLI level being above a first threshold level, the first network device transmits a first indication to the second network device. The first indication comprises service information associated with the CLI.

In a second aspect, there is provided a method implemented at a second network device. In the method, the second network transmits at least one Cross Link Interference (CLI)-Reference Signal (RS) to a first network device operating in a subband full-duplex mode. The second device receives a first indication from the first network device, the first indication comprising service information associated with the CLI, and performs a CLI elimination procedure based on the first indication.

In a third aspect, there is provided a method implemented at a third network device operating in a subband full-duplex. In the method, the third network device receives a CLI measurement report from a first terminal device configured with a first service, the CLI measure report comprising CLI measurement level. In response to the CLI measurement value being above a first threshold level, the third network device transmits, to at least one second terminal device configured with a second service, a first indication for eliminating CLI by the second terminal device, priority of the first service is higher than priority of the second service.

In a fourth aspect, there is provided a method implemented at a second terminal device. In the method, the terminal device transmits at least one CLI-RS. The second terminal device receives, from a third network device operating in a subband full-duplex mode, a first indication for eliminating a CLI by the second terminal device.

In an fifth aspect, there is provided a network device. The network device comprises a processor and a memory coupled to the processor and storing instructions thereon, the instructions, when executed by the processor, causing the network device to perform the method of any one of the first aspect to third aspect.

In a sixth aspect, there is provided a terminal device. The terminal device comprises a processor and a memory coupled to the processor and storing instructions thereon, the instructions, when executed by the processor, causing the terminal device to perform the method of the fourth aspect.

In a seventh aspect, there is provided a computer readable medium having instructions stored thereon, the instructions, when executed on at least one processor, causing the at least one processor to perform the method of any one of the first aspect to the fourth aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which some embodiments of the present disclosure can be implemented;

FIG. 2 illustrates a signaling process of the management of CLI between network devices according to some embodiments of the present disclosure:

FIG. 3 illustrates an example environment in which some embodiments of the present disclosure can be implemented:

FIG. 4 illustrates a signaling process of the management of CLI between a network device and terminal devices according to some embodiments of the present disclosure:

FIG. 5 illustrates an example uplink transmission scheduling according to some embodiments of the present disclosure:

FIG. 6 illustrates a flowchart of an example method implemented at a first network device in accordance with some embodiments of the present disclosure:

FIG. 7 illustrates a flowchart of an method implemented at a second network device in accordance with some embodiments of the present disclosure;

FIG. 8 illustrates a flowchart of an example method implemented at a third network device in accordance with some embodiments of the present disclosure:

FIG. 9 illustrates a flowchart of an example method implemented at a second terminal device in accordance with some embodiments of the present disclosure; and

FIG. 10 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term ‘terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has “multicast/broadcast” feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information. The terminal or the network device may work on several frequency ranges, e.g. FR1 (410 MHz-7125 MHz), FR2 (24.25 GHz to 71 GHz), 71 GHz to 114 GHZ, and frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes and its variants are to be read as open terms that mean ‘includes, but is not limited to.” The term ‘based on’ is to be read as “at least in part based on.” The term “one embodiment and ‘an embodiment’ are to be read as “at least one embodiment.” The term “another embodiment” is to be read as “at least one other embodiment.” The terms “first,” “second, and the like may refer to different or same objects. Other definitions, explicit and implicit, may be included below:

In some examples, values, procedures, or apparatus are referred to as ‘best,” lowest,” “highest,” ‘minimum,’ ‘maximum’, or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In this disclosure, TDD mode comprises the (half) duplex communication links where UL is separated from DL by the allocation of different time units in the same frequency channel. FDD mode refers to the duplex communication links where separate frequency bands are used at the transmitter and receiver side. The network device in this disclosure may operate in a non-overlapping subband full duplex mode in which the network device is enabled to receive UL and transmit DL simultaneously by using different frequency channel subbands for different terminal devices. The network device in this disclosure may operate in a full duplex mode in which the network device is enabled to operate UL transmission and DL transmission simultaneously by using same frequency band with a terminal device.

As mentioned above, the CLI may be occurred between different network devices of which at least one network device operates in the sub-band full duplex communication mode. However, for network devices operating in the full duplex communication mode, there is no specific mechanism for CLI management.

The example embodiments of the disclosure propose a mechanism for CLI management. In this mechanism, a first network device operating in a subband full-duplex mode measures a CLI level based on at least one CLI-Reference Signal (RS) received from a second network device. The second device operates in the TDD mode or sub-band full duplex mode. The CLI-RS may comprise new designed RS for the CLI measurement, or compirse existing RSs, for example, SRS or CSI-IM-RS or DMRS, which are reused for the CLI measurement. In response to the measured CLI level being above a first threshold, the first network device transmits a CLI elimination assistance indication to a second device for eliminating CLI from the second network device. The first indication comprises service information associated with the CLI. Then, the second network device performs a CLI elimination procedure based on the CLI elimination assistance indication to elimate the CLI from the second network device. Further, in response to the measured CLI level being above a second threshold level, the first network device transitions from the subband based full-duplex mode to a TDD mode.

In this way, the victim network device operating in the subband based full-duplex mode may indicate at least one aggressor network device to perform the CLI elimination procedure based on the service information associated with the CLI. For example, the aggressor network device may cancel a respective DL transmission based on the CLI elimination assistance indication or determine how to schedule the respective DL transmission based on the service information to avoid generating CLI to the victim network device. In addition, the victim network device may transition from the subband full-duplex mode to a TDD configuration to coordinate the UL or DL transmission with the aggressor network device.

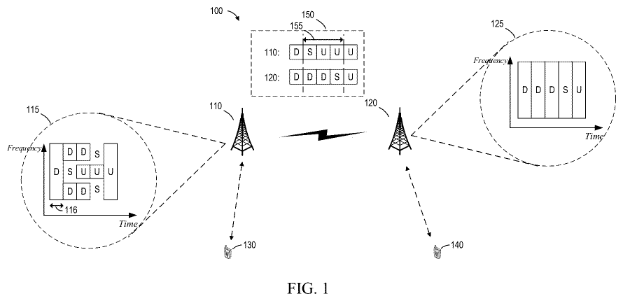

FIG. 1 illustrates an example environment 100 in which example embodiments of the present disclosure can be implemented.

The environment 100, which may be a part of a communication network, comprises a first network device 110, a second network device 120, a first terminal device 130 and a second terminal device 140. At least the first network device 110 may operate in the subband based full-duplex mode. The transmission configuration 115 illustrates an example UL and DL transmission pattern of the first network device 110 operating in the subband based full-duplex mode. In this disclosure, the time unit 116 in the transmission configuration 115 may comprise a slot. In addition or alternatively, the time unit 116 may comprise any other unit in time domain, for example, a symbol, a frame or a subframe. As shown in the transmission configuration 115, “D” refers to a time unit used for the DL transmission, “U” refers to a time unit used for the UL reception and “S” refers to a flexible time-frequency unit which may be used for DL transmission or UL reception on demand. In some embodiments, the S time-frequency unit may be used for the guard gap between the DL transmission or UL reception. In an example, as shown in the configuration 115, in the second, third and fourth time units, the first network device 110 may perform the DL transmission for a group of terminal devices and the UL reception for another group of UEs simultaneously on different frequency subband. In the first time unit, the first network device 110 only performs the DL transmission. In turn, in the fifth time unit, the first network device 110 only performs the UL transmission.

In addition, the transmission configuration 125 illustrates an example TDD transmission pattern of the second network device 110. In the TDD transmission pattern, the second network device 120 may perform the DL transmissions in the first, second and third time units and perform the UL reception in the fifth time unit. The fourth time unit is a flexible time unit. In the above cases, the transmissions in the second, third and fourth time units may be conflicted between the first network device 110 and the second network device 120. As shown in the block 150, the first row refers to the TDD configuration 115 of the second sub-band of the first network device 110, and the second row refers to the TDD configuration 125 of the second network device 120. It can be seen that in the above example situations, the DL transmission and UL reception in the time units indicated by the length 155 may be conflicted between the network devices. It is to be understood that the transmission configurations as discussed above are shown in the environment 100 only for the purpose of illustration, without suggesting any limitation to the scope of the present disclosure.

In addition, the first network device 110 may perform DL transmission and/or UL reception with the first terminal device 130. In turn, the second network device 120 may perform DL transmission and/or UL reception with the second terminal device 140.

It is to be understood that the number of terminal devices and network device is shown in the environment 100 only for the purpose of illustration, without suggesting any limitation to the scope of the present disclosure. In some embodiments, the environment 100 may comprise a further terminal device to communicate information with a further network device.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

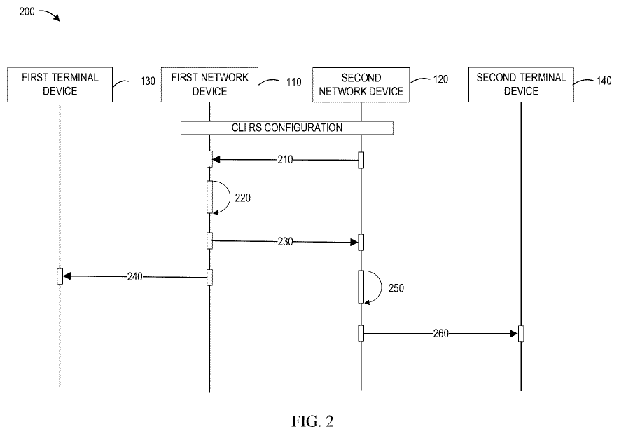

FIG. 2 illustrates a signaling process 200 of the management of CLI between network devices according to some embodiments of the present disclosure. For purpose of discussion, the process 200 will be described with reference to FIG. 1.

In the signaling process 200, the first network device 110 measures (210) a CLI level based on at least one CLI-RS received from the second network device 120. In some embodiments, the CLI-RS configuration is specially configured for inter-gNB CLI measurement. In some embodiments, the CLI-RS configuration is predefined. For example, the predefined CLI-RS configuration indicates the association between a communication resource and a CLI-RS. The second network device 120 may transmit a plurality of CLI-RS on an associated plurality of communication resources. In some embodiments, the associated plurality of communication resources is used for UL reception by the first network device 110 while is used for DL transmission by the second network device 120. The first network device 110 may measure signal reception strength for each of the plurality of CLI RSs transmitted on the respective plurality of communication resources. Then, the first network device 110 may determine a CLI level associated with a respective communication resource based on the plurality of received CLI-RSs. In addition or alternatively, the first network device 110 and the second network device 120 may reuse the existing RS for measuring the CLI level without predefining the CLI-RS configuration. In addition or alternatively, the first network device 110 may negotiate a CLI-RS in real time without the predefined CLI-RS configuration. In some embodiments, the first network device 110 may measure the CLI level in any other manner.

The first network device 110 then compares (220) the measured at least one CLI levels with a first threshold level. In some embodiments, the first threshold level is predefined for a first service/traffic having high priority. For example, the first service/traffic comprises at least one of: Ultra-Reliable and Low Latency Communication (URLLC) service, Industrial Internet of Things (IIoT) service and Extended Reality (XR) service. These services/traffics have higher requirements for the latency and reliability of the communication. In an example, the first network device 110 may schedule the first service/traffic on a set of communication resources. The first network device 110 may measure a set of CLI levels on the set of communication resources, for example, a set of slots. In turn, the first network device 110 may compare the set of CLI levels with the first threshold level. If there is a CLI level is above the first threshold level, the associated communication resource, for example a UL sub-band in a slot, is determined as being affected by the CLI from the second network device 120. The CLI on the communication resource should be eliminated to erasure the communication quality of the first service/traffic to be performed. In addition or alternatively, the first threshold level is predefined for other purposes or can be adjusted dynamically:

In response to the measured CLI level is above the first threshold level, the first network device 110 may determine that the CLI cannot be eliminated at the first network device 110 without the assistance of the second network device 120. In turn, the first network device 110 may transmit (230) a CLI elimination assistance indication (which may be also referred as “a first indication” in the following) to the second network device 120 for eliminating the CLI from the second network device 120. The first indication comprises service information associated with the CLI. It is to be understood that the number of the second network device 120 is illustrated only for purpose of discussion. The first network device 110 may transmit the first indication to one or more second network devices which may affect the service/traffic of the first network device 110. In response to receiving the CLI elimination assistance indication, the second network device 120 performs a CLI elimination procedure for eliminating the CLI from the second network device.

Regarding the transmission of the first indication, the first network device 110 may transmit the first indication directly to the second network device 120 on a Xn interface. In addition or alternatively, the first network device 110 may transmit the first indication to the second network device 120 via Operations and Maintenance (OAM) functionality: In addition or alternatively, the first indication may have a form of a new defined reference signal which may be discussed in the following.

In some embodiments, the first indication may comprise a CLI elimination request for disabling a DL transmission on a communication resource. Once received the CLI elimination request, the second network device 120 may cancel the DL transmission on the communication resource indicated in the request. Further, the second network device 120 may inform (260) the second terminal device 140 with the cancellation of the DL transmission on the communication resource.

In some embodiments, the CLI elimination request may comprise at least one of: a subband based TDD configuration of the first network device 110: a priority of a service on each sub-band: the type or QoS of service suffering CLI, and the communication resource of the sub-band suffering CLI.

In an example, the CLI elimination request comprises the subband based TDD configuration of the first network device 110, for example, the configuration 115 as shown in FIG. 1. In this case, the second network device 120 may determine the communication resource which may be affected by the CLI based on the TDD configuration 115 and the TDD configuration of the second network device 120, for example, the configuration 125 as shown in FIG. 1. For example, the second network device 120 may determine the time units in the length 155 shown in the FIG. 1 to be the unavailable communication resource. In another example, the second network device 120 may also determine the unavailable frequency resources, for example, one or more subbands, based on the TDD configuration 115 and TDD configuration of the second network device 120. Then, the second network device cancels the DL transmissions on these communication resources. In addition, the second network device 120 further informs (260) the second terminal device 140 with the cancellation of DL transmission for the energy saving at the terminal devices.

In some embodiments, the second network device 120 may indicate these communication resources, for example, slots, to the second terminal device 140 by Downlink Control Information (DCI). For example, the second network device 120 may transmit an indication (which may be referred as a fourth indication) of the communication resources. In addition or alternatively, a new group common DCI format 2_x may be introduced to indicate the DL cancelation in a certain communication resource. For example, the communication resource disabled for DL transmission is indicated by a bit field having DCI format, a first state of a bit in the bit field indicating a time unit on which a Downlink (DL) transmission is to be disabled. In an example, a bit filed “01110” corresponds to slot 0)-slot 4, the second terminal device 140 may assume there is no DL transmission in slot 1˜slot 3.

In addition or alternatively, existing DCI-format 2_1 may be enhanced for indicating these communication resources. For example, larger time granularity and/or smaller frequency granularity may be introduced.

In another example, the CLI elimination request comprises the communication resource of the subbands suffering CLI, after receiving the CLI elimination request, the second network device 120 may directly determine these subbands unavailable for DL transmission without comparing the TDD configuration and the full-duplex mode. For example, the second network device may set the frequency resources in its DL BWP overlapping with UL sub-band of the first network device as unavailable resources. In this case, the second network device 120 may cancel the DL transmission on these communication resources. In turn, the second network device 120 may informs the second terminal device 140 with these communication resources similarly. For example, the second network device 120 may inform the communication resource in the same way as discussed above. In another example, the second network device 120 may inform the communication resource by a group common DCI/RRC/MAC CE. In turn, the second terminal device 140 may cancel the DL reception on the indicated communication resources accordingly. In this way, the energy saving at the terminal device can be achieved.

In addition or alternatively, the second network device 120 may send an indication for a group of terminal devices to update/switch the reception-beam for the earlier scheduled DL transmission, wherein the updated beam information may be determined at second network device 120 based on the required beam directions of the first network device 110. Then, the terminal devices may update the beams for DL reception accordingly.

In a further example, the CLI elimination request indicates the priority of service which is affected by the CLI. Once receiving the priority of service, the second network device 120 may determine whether to perform a CLI elimination procedure based on the priority: For example, if the priority is higher than a threshold level, the second network device 120 may cancel DL transmission and inform the terminal devices.

In some embodiments, as discussed above, the first indication may have a form of a new defined reference signal. In this case, the service/traffic may be indicated by a set of new defined RSs. For example, the set of RSs comprises a plurality of sequences, and each sequence of the plurality of sequences corresponds to a respective service. In another example, the set of new defined RSs comprises one RS, and the RS may be mapped to different communication resources, and the service may be indicated by the communication resource which the RS is mapped to.

In addition to the completely disabling DL transmission on the indicated communication resources or alternatively, the second network device 120 may have autonomy: In some embodiments, the second network device may compare (250) the first priority of the service (which may referred as a third service of the first network device 110) affected by the CLI with the second priority of a service (which may be referred as a fourth service) to be performed by DL transmission and determines whether to perform the DL transmission.

In some embodiments, the second network device 120 may determine the first priority of the third service based on the service information associated with the CLI contained in the first indication. For example, the service information may indicate the priority of the third service of the first network device 110 directly. In another example, the service information may indicate the communication requirement of the third service, for example, latency or reliability. Then, the second network device 120 may determine the first priority correspondingly. In addition or alternatively, the service information may indicate the first priority in any other manner. For example, the priority may be associated with the communication resource, the above communication resources indicated in the first indication may reflect the first priority implicitly. In some embodiments, the first priority may be represented as service type, Quality of Service (QOS) of the service or any other parameter relating to communication requirements. In this way, the first priority may be also indicated by the new defined RSs as discussed above.

With the determined first priority; the second network device 120 compares the first priority with the second priority of the service to be performed by DL transmission. If the first priority is higher than the second priority, the second network device 120 may cancel the DL transmission and inform (260) the terminal devices the cancelation of the DL transmission in the same way as discussed above. In addition or alternatively, if the first priority is not higher than the second priority, the second network device 120 may perform the DL transmission normally.

In addition or alternatively, if the second network device 120 obtain the mode information indicating that a neighboring network device 110 is operating in a subband based full duplex mode, the second network device 120 may perform a sensing procedure before performing the DL transmission, even if receiving no first indication as discussed above. The sensing procedure may comprise a Listen Before Talk (LBT) procedure, Clear Channel Assessment (CCA) procedure or any other similar procedure.

In some embodiments, the second network device 120 may determine whether to perform the sensing procedure based on the service to be performed. For example, if the DL transmission (for example, being performed on a communication resource overlapped with UL sub-band of the first network device 110) is used for high priority service, for example, IIoT/URLLC, the second network device 120 will directly perform the DL transmission without the sensing procedure. In addition or alternatively, if the the DL transmission is used for low priority service, for example, eMBB or MTC, the second network device 130 should perform sensing procedure in advance to determine whether it can send the DL transmission.

At the first network device 110 side, the CLI elimination procedure may be also performed. For example, in response to the measured CLI level is above a second threshold level, the first network device 110 may transition from the subband full-duplex mode to a TDD mode. In some embodiments, the second threshold level is configured for a second service having low priority: The second service may be a service which requires a lower latency or reliability: For example, the second service may comprise an Enhanced Mobile Broadband (EMBB) service.

Since the second service requires a lower latency or reliability, the first network device 110 may transition from the subband based full-duplex mode to the TDD configuration. For example, if the measured CLI level being above a second threshold level or below the second threshold, the first network device 110 may transition from the subband based full duplex mode to the TDD configuration which is coordinated with the TDD configuration 125 of the second network device 120. In this case, the TDD configuration of the first network device 110 and the TDD configuration 125 are matched. Accordingly, the CLI can be eliminated.

In addition, the first network device 110 may transmit (240) to terminal devices, for example the first terminal device 110, an indication (which may be referred as a second indication) indicating that the first network device 110 has transitioned from the subband full-duplex mode to the TDD mode. With the reception of the second indication, the first terminal device 130 may cancel the UL transmission to be performed and re-arrange the data to be performed based on the TDD mode.

In some embodiments, the second indication may be transmitted in a group common DCI 2_0 signaling (which may be referred to be first group common DCI signaling). For example, if the higher layer parameter slotFormatUpdateForCLI is configured, DCI format 2_0 can update the TDD configuration for a group of terminal devices to switch the UL/flexible time units to DL time units.

In addition or alternatively, the second indication may be transmitted in a System Information Block (SIB) signaling. For example, by introducing a parameter/field, duplexModeIndication. 1-sub-band duplex mode. 0-TDD mode. if the field doesn't exist, TDD mode is applied.

In addition or alternatively, the second indication may be indicated by RRC reconfiguration.

Further, in addition or alternatively to the second indication, the first network device 110 may also transmit (240) an indication for postponing UL transmission (which may be refrred as a third indication). The third indication may be transmitted in a group common DCI. In an example, the third indication indicates to postpone the UL transmission in the UL sub-band in the full duplex slot n to slot n+k, k is indicated by the DCI. In this case, the first network device 110 is not required to transition to the TDD configuration, and only the UL transmission is postponed.

In the way discussed above, the CLI on the full duplex network device may be eliminated by the first network device 110 and/or by the second network device 120 in different situations. Further, the cancelation of the transmission may be informed to the terminal devices for energy saving.

In addition or alternatively, the above operations for CLI management between the first network device 110 and the second network device 120 may be also expressed in the following:

DCI format 2_x is used for notifying the slots and/or sub-band(or PRB group) where UE
may assume no DL transmission is intended for the UE or where UE cancels the
corresponding (low priority) UL transmission(or cancels the corresponding DL reception)
from the UE according to Clause 11.x of [5, TS 38.213].
Identifier for DCI formats - 1 bit
The value of this bit field is set to 0 for UL Tx cancellation; the value of this bit field is set
to 1 for DL Rx cancellation
The following information is transmitted by means of the DCI format 2_x with CRC
scrambled by cli-RNTI:
CLI indication 1, CLI indication 2, ..., CLI indication N.
The size of DCI format 2_x is configurable by higher layers parameter dci-
PayloadSizeForCLI up to y bits, according to Clause 11.x of [5, TS 38.213]. The number
of bits for each CLI indication is configurable by higher layer parameter CLI-PayloadSize.

```
DCI format 2_1 is used for notifying the PRB(s) and/or OFDM symbol(s)/slot(s) where
UE may assume no transmission is intended for the UE.
If a UE is provided DownlinkPreemption, the following information is transmitted by
means of the DCI format 2_1 with CRC scrambled by INT-RNTI:
  - Pre-emption indication 1, Pre-emption indication 2, ..., Pre-emption indication N.
The size of DCI format 2_1 is configurable by higher layers up to 126 bits, according to
Clause 11.2 of [5, TS 38.213]. Each pre-emption indication is 14 bits.
If a UE is provided CrossLinkInterferneceIndicationForDl , the following information is
transmitted by means of the DCI format 2_1 with CRC scrambled by CLI-RNTI:
  - CLI indication 1, CLI indication 2, ..., CLI indication N.
The size of DCI format 2_x is configurable by higher layers up to y bits, according to
Clause 11.x of [5, TS 38.213]. Each CLI(cross link interference) indication is N bits.
```

```
If a UE is provided CrossLinkInterferneceIndicationForDl , the UE is configured with an
CLI-RNTI provided by CLI-RNTI for monitoring PDCCH conveying DCI format 2_x/2_1
[5, TS 38.212]. The UE is additionally configured with
  - a set of serving cells by CLI-ConfigurationPerServingCell that includes a set of
serving cell indexes provided by corresponding servingCellId and a corresponding set of
locations for fields in DCI format 2_x by positionCLIDCI
      - an information payload size for DCI format 2_x by dci-PayloadSize
  Opt.1:
  - an bit mapping indication for unavailable DL reception(s) in slots of a TDD
configuration period by BitMapIndicationForCli
If a UE detects a DCI format 2_x for a serving cell from the configured set of serving cells,
the UE may assume that no DL transmission to the UE is present in the set of slots that are
indicated by the DCI format 2_x, from a TDD configuration period after receiving the
PDCCH carrying DCI format 2_x. The indication by the DCI format 2_1 is not applicable
to receptions of SS/PBCH blocks.
  Opt.2:
    - an indication granularity for frequency resources by FrequencySet
If a UE detects a DCI format 2_1 for a serving cell from the configured set of serving cells,
the UE may assume that no transmission to the UE is present in a indicated sub-band or
PRB group and in slots that are indicated by the DCI format 2_1, from a set of PRBs and
a set of slots of the last monitoring period.
The set of PRBs is equal to the active DL BWP as defined in clause 12 and includes N
PRBs.
```

The mechanism discussed with reference to FIGS. 1-2 may be used for eliminating the CLI caused by another network device. However, the network device operating in the subband based full duplex mode may be also experienced the CLI caused by the terminal device served by the network device. For example, when an UL transmission (PUCCH/PUSCH) for eMBB service is scheduled or configured for a first terminal device in a UL subband in a slot, the network device may schedule an urgent DL transmission (PDSCH) for another terminal device in a DL subband in the same slot for URLLC/XR service with higher reliability requirement. Further, the UL subband and the DL subband may be adjacent with each other. However, adjacent channel interference between these two terminal devices within the cell provided by the network device may occur, for example, cross link interference from the other terminal device to the terminal device. While the traditional solution to preconfigure the default guard band in FDD may not suit well for sub-band full duplex, since the guard band of FDD is too large, which will reduce spectrum efficiency, especially when the victim terminal device is configured with high reliability service, for example, XR or URLLC service. Therefore, other enhanced solutions can be studied.

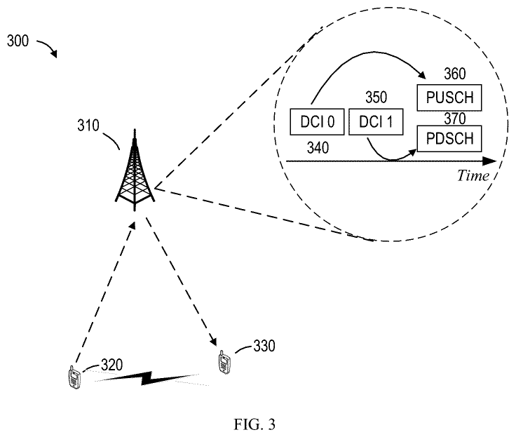

FIG. 3 illustrates an example environment 300 in which some embodiments of the present disclosure can be implemented.

The environment 300, which may be a part of a communication network, comprises a third network device 310, a first terminal device 330 and a second terminal device 320. Assuming that the third network device 310 operating in the subband based full duplex mode schedules for the second terminal device 320 with the PUSCH 360 in a slot for the second service in advance by the DCI 340, and schedules for the first terminal device 330 with the PDSCH 370 in the same slot for the first service 330 by the DCI 350. Priority of the first service is higher than the priority of the second service. In this case, if the guard band is not enough, the CLI may be occurred at the network device 310 operating in the full duplex mode, the requirement of DL reception of service with high priority will be not satisfied.

It is to be understood that the number of terminal devices and network device is shown in the environment 300 is only for the purpose of illustration, without suggesting any limitation to the scope of the present disclosure. In some embodiments, the environment 300 may comprise a further terminal device to communicate information with a further network device.

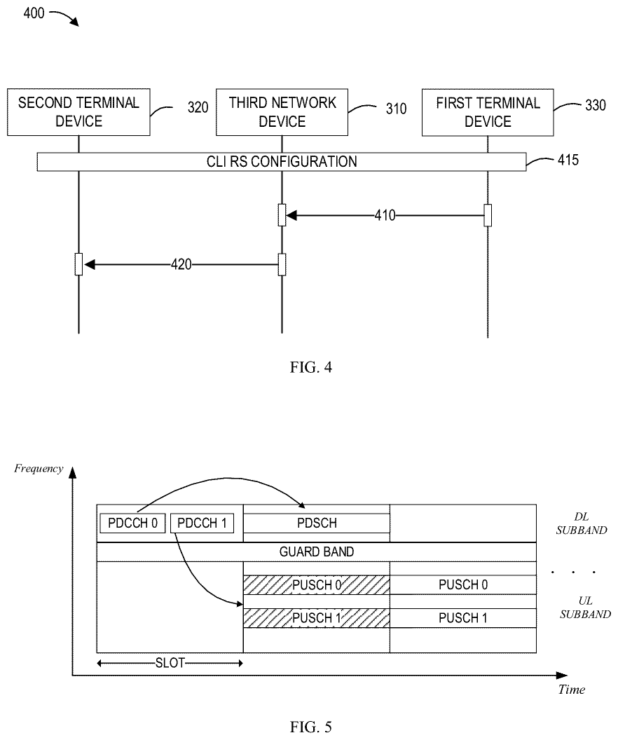

FIG. 4 illustrates a signaling process 400 of the management of CLI between network device and terminal device according to some embodiments of the present disclosure. For purpose of discussion, the process 400 will be described with reference to FIG. 3.

In the signaling process 400, the third network device 310 receives (410) a CLI measurement report from a first terminal device 330 configured with a first service. In some embodiments, the second terminal device 320 may transmit at least one CLI-RS based on a preconfigured CLI RS configuration. As discussed above, the CLI RS comprises existing RSs, for example SRS, DMRS, and/or new designed RS. Then, the first terminal device 330 may measure the CLI level based on the CLI RS configuration. The first terminal device 330 further generate the CLI measure report comprising the CLI level and transmit the CLI measurement report to the third network device 310. In some embodiments, the CLI RS configuration 415 can be preconfigured in the same way as discussed with reference to FIG. 2.

If the CLI measurement level is above a first threshold, the third network device 310 transmits (420) a first indication to at least one terminal device, for example, the second terminal device 320, for eliminating CLI by the terminal devices.

In some embodiments, the first indication may comprise a muting pattern indicating a set of time units. For example, the muting pattern may comprise a bit field having DCI format, a first state of a bit in the bit field indicates a time unit on which an Uplink (UL) transmission is to be disabled. In an example, the bit filed “100001” is associated with six time units, and the first one and last one of the six time units are indicated to be disabled for UL transmission.

In some embodiments, the muting pattern can be transmitted in the current DCI or a new DCI format. In addition or alternatively; the muting pattern can be indicated by enhanced DCI format 2_4 with introducing new large time granularities, e.g., slot(s). In addition or alternatively, the muting pattern can be indicated by reusing the group common DCI format 2_4.

In some embodiments, the muting pattern may be determined based on the periodicity of the DL transmission of first service. For example, if there is a SPS configuration associated with high priority service, then the muting pattern is determined based on the periodicity of the SPS configuration, then the CLI generating by UL transmission in the slot(s) for the SPS PDSCH transmission can be avoided.

Upon receiving the muting pattern, the at least one second terminal device 320 will not perform UL transmission on the time units indicated in the muting pattern.

In addition or alternatively, the first indication may comprise a time pattern, and the time pattern comprises a first part indicating an UL transmission to be postponed. For discussing clearly, the first indication comprising the time pattern is discussed with reference to FIG. 5.

FIG. 5 illustrates an example uplink transmission scheduling according to some embodiments of the present disclosure.

As shown in FIG. 5, the third network device 310 earlier configures a configured grant (CG) PUSCH #0 for the second terminal device and a CG PUSCH #1 for the third terminal device, while the third network device 310 schedules an urgent PDSCH with high priority in the same slot for the first terminal device 330 by PDCCH #0. In order to avoid the CLI generated by CG PUSCH #0 and CG PUSCH #1 to the PDSCH reception, the third network device 310 transmits a PDCCH #1 with the first indication. Upon receiving the first indication comprising a first part, the second terminal device 320 postpones the PUSCH 0) and the third terminal device postpones the PUSCH 1 to the next one or more time units. In an example of FIG. 5, the second terminal device 320 postpones the PUSCH 0 and the third terminal device postpones the PUSCH 1 by one slot. It is to be understood that the PUSCH 0 and PUSCH 1 may be postponed by a plurality of slots.

Referring back to FIG. 4, the time pattern may comprise a second part indicating an Uplink (UL) transmission on which a frequency offset to be performed. For example, the third network device 130 may indicate a CLI handling signaling by a group common DCI for at least one terminal devices contributing interference. The CLI handling signaling indicates the terminal devices, for example, the second terminal device 320, to perform frequency offset for the UL transmission in the slot, such that guard band between DL transmission and UL transmission can be enlarged. In other word, the guard band in frequency domain between DL sub-band and UL sub-band can be adjusted dynamically. In some embodiments, the offset value is also indicated by the DCI. In addition or alternatively, the offset may be predefined.

In addition or alternatively, the third network device 310 may transmit a sensing configuration indicating the second terminal device 320 to perform a sensing procedure before a UL transmission. In this case, the second network device 320 may perform a sensing procedure before performing the UL transmission. In some embodiments, the second terminal device 320 determines whether a third priority of a UL transmission to be performed is above a priority threshold. If the third priority is above the priority threshold, the second terminal device 320 performs the UL transmission without the sensing procedure. In turn, if the third priority is not above the priority threshold, the second terminal device 320 performs the sensing procedure before the UL transmission. The priority threshold may be predefined or adjusted dynamically. For example, if there are only two services to be performed by the second terminal device 320, the lower priority of these two services may be determined as the priority threshold. Further, the priority threshold may be determined for other purposes.

In some embodiments, the third network device 310 may indicate the second network device 320 to perform spatial filter to eliminate the CLI caused by the device 320. In an example, when UL transmission is configured or scheduled for a set of terminal devices in a UL sub-band in a slot n, if the third network device 310 schedules a DL transmission for the first terminal device 330 in a DL sub-band in the same slot n and the CLI measurement result value (e.g., RSRP) from the first terminal device 330 is larger than a threshold value, the third network device 310 may indicate a CLI handling signaling by a group common DCI for the set of terminal devices to adjust/update the transmission beams for the UL transmission in the slot, the updated beam information is carried in the DCI.

In this way, with the cancelation of UL transmission, postponing the UL transmission, indicating a subband offset or spatial filter, the CLI occurred in the same cell provided by a network device operating in the full duplex mode can be eliminated.

In addition or alternatively, the above operations for CLI management between the network device 310 and terminal devices 320 and 330 may be also expressed in the following:

```
DCI format 2_x is used for notifying the set of slots where UE cancels the corresponding
low priority UL transmission(or cancels the corresponding DL reception) from the UE
according to Clause 11.x of [5, TS 38.213].
Identifier for DCI formats - 1 bit
  - The value of this bit field is set to 0 for UL Tx cancellation; the value of
this bit field is set to 1 for DL Rx cancellation
The following information is transmitted by means of the DCI format 2_x with CRC
scrambled by cli-RNTI:
  - CLI indication 1, CLI indication 2, ..., CLI indication N.
The size of DCI format 2_x is configurable by higher layers parameter dci-
PayloadSizeForCLI up to y bits, according to Clause 11.x of [5, TS 38.213]. The number
of bits for each CLI indication is configurable by higher layer parameter CLI-PayloadSize.
```

DCI format 2_4 is used for notifying the PRB(s)/sub-band and OFDM symbol(s)/slot(s)
where UE cancels the corresponding UL transmission from the UE according to Clause
11.2A of [5, TS 38.213].
The following information is transmitted by means of the DCI format 2_4 with CRC
scrambled by ci-RNTI:
- Cancellation indication 1, Cancellation indication 2, ..., Cancellation indication
indication N.
The size of DCI format 2_4 is configurable by higher layers parameter dci-
PayloadSizeForCI up to 126 bits, according to Clause 11.2A of [5, TS 38.213]. The number
of bits for each cancellation indication is configurable by higher layer parameter ci-
PayloadSize. For a UE, there is at most one cancellation indication for an UL carrier.

```
A UE that detects a DCI format 2_x for a serving cell cancels a UL transmission(PUSCH
or SRS) [6, TS 38.214] on the serving cell for CLI management if,
  - the UL transmission is with low priority class, if the UE is provided
PriorityIndicatorField ,
  - a group of slots, from the T slots, has at least one bit value of ‘1’ in the
corresponding set of N_{BI} bits from CLI indication in the DCI format 2_x and includes a
slot of the UL transmission, and
  where
  - the cancellation of the UL transmission in the corresponding UL sub-band in the
indicated slots having corresponding bit values of ‘1’ in the DCI format 2_x;
```

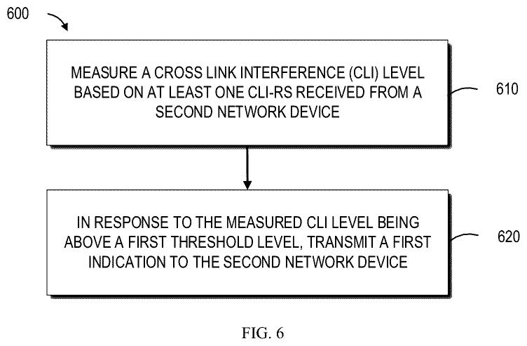

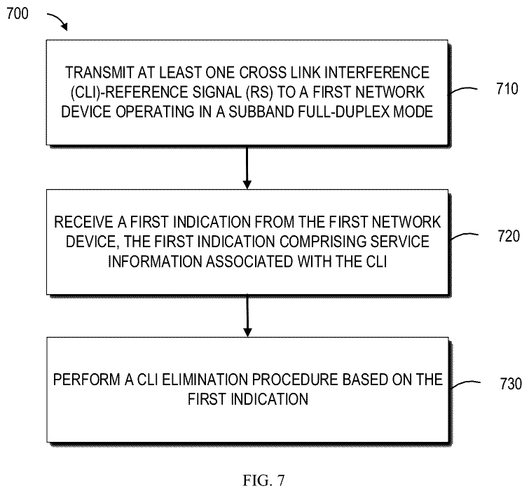

FIG. 6 illustrates a flowchart of an example method 600 of communication implemented at a first network device in accordance with some embodiments of the present disclosure. The method 600 can be implemented at the first network device 110 shown in FIG. 1. For the purpose of discussion, the method 600 will be described with reference to FIG. 1. It is to be understood that the method 600 may include additional acts not shown and/or may omit some shown acts, and the scope of the present disclosure is not limited in this regard.

At block 610, the first network device 110 measures a CLI level based on at least one CLI-Reference Signal (RS) received from a second network device.

At block 620, in response to the measured CLI level being above a first threshold level, the first network device transmits a first indication to the second network device. The first indication comprises service information associated with the CLI.

In some embodiments, the first threshold level is configured for a first service, and wherein the first indication further comprises a CLI elimination request for disabling a Downlink (DL) transmission on a communication resource.

In some embodiments, the CLI elimination request comprises at least one of: a subband based Time Division Duplex (TDD) configuration of the first network device; a priority of a service; and the communication resource.

In some embodiments, the CLI elimination request comprises a set of RSs, wherein each RS of the set of RSs corresponds to a respective service.

In some embodiments, the first service comprises at least one of: Ultra-Reliable and Low Latency Communication (URLLC) service: Industrial Internet of Things (IIoT) service; and Extended Reality (XR) service.

In some embodiments, the communication resource is indicated by a bit field having DCI format, a first state of a bit in the bit field indicating a time unit on which a Downlink (DL) transmission is to be disabled.

In some embodiments, in response to the measured CLI level being above a second threshold level, the first network device 110 transitions from the subband full-duplex mode to a TDD mode.

In some embodiments, the second threshold level is configured for a second service, and the method further comprising: transmitting, to a terminal device, a second indication indicating that the first network device has transitioned from the subband full-duplex mode to the TDD mode.

In some embodiments, transmitting the second indication comprises at least one of: transmitting the second indication in a first group common Downlink Control Information (DCI) signaling: transmitting the second indication in a System Information Block (SIB) signaling; and transmitting the second indication by a RRC reconfiguration.

In some embodiments, the second service comprises an Enhanced Mobile Broadband (EMBB) service.

In some embodiments, further comprising: transmitting, to a terminal device, a third indication for postponing Uplink (UL) transmission to be transmitted from the terminal device.

FIG. 7 illustrates a flowchart of a method 700 of communication implemented at a second network device in accordance with some embodiments of the present disclosure. The method 700 can be implemented at the second network device 120 shown in FIG. 1. For the purpose of discussion, the method 700 will be described with reference to FIG. 1. It is to be understood that the method 700 may include additional acts not shown and/or may omit some shown acts, and the scope of the present disclosure is not limited in this regard.

At block 710, the second network device 120 transmits at least one Cross Link Interference (CLI)-Reference Signal (RS) to a first network device operating in a subband full-duplex mode.

At block 720, the second network device 120 receives a first indication from the first network device, the first indication comprising service information associated with the CLI.

At block 730, the second network device 120 performs a CLI elimination procedure based on the first indication.

In some embodiments, the first indication further comprises a CLI elimination request for disabling a Downlink (DL) transmission on a communication resource.

In some embodiments, the CLI elimination request comprises at least one of: a subband based Time Division Duplex (TDD) configuration of the first network device: a priority of a service; and the communication resource.

In some embodiments, the CLI elimination request comprises a set of RSs, wherein each RS of the set of RSs corresponds to a respective service.

In some embodiments, the communication resource is indicated by a bit field having DCI format, a first state of a bit in the bit field indicating a time unit on which a Downlink (DL) transmission is to be disabled.

In some embodiments, performing the CLI elimination procedure comprises: determining the communication resource on which a Downlink (DL) transmission is to be disabled based on the CLI elimination request; and performing no Downlink (DL) transmission on the determined communication resource.

In some embodiments, determining the communication comprises: determining the communication resource based on a second TDD configuration of the second device and the subband based TDD configuration in the CLI elimination request.

In some embodiments, performing the CLI elimination procedure comprises:
transmitting, to a terminal device associated with the second network device, a fourth indication indicating to cancel the reception on the communication resource.

In some embodiments, transmitting the fourth indication comprises: transmitting the fourth indication in at least one of an enhanced DCI format and a second group common Downlink Control Information (DCI) signaling.

In some embodiments, performing the CLI elimination procedure comprises: determining a first priority of a third service affected by the CLI based on the service information associated with the CLI: determining whether the first priority is higher than a second priority of a fourth service to be performed by the second device; and in accordance with a determination that the first priority is higher than the second priority, performing a interference cancellation mechanism for the third service: or in accordance with a determination that the first priority is not higher than the second priority, performing the DL transmission for the fourth service.

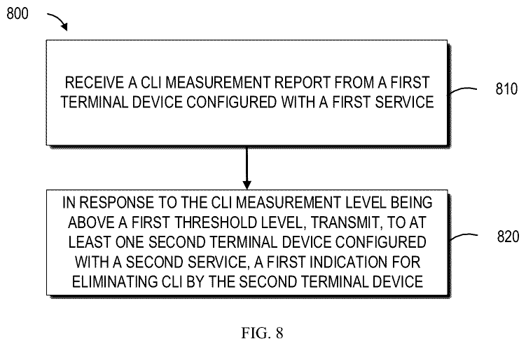

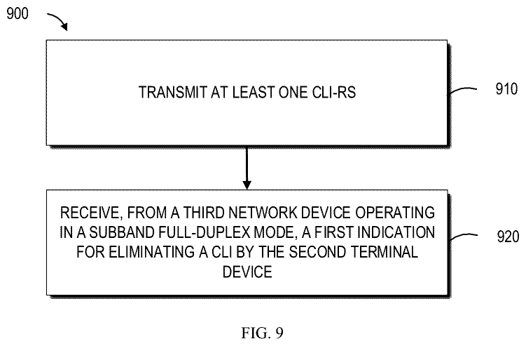

FIG. 8 illustrates a flowchart of a method 800 of communication implemented at a third network device in accordance with some embodiments of the present disclosure. The method 800 can be implemented at the third network device 310 shown in FIG. 3. For the purpose of discussion, the method 800 will be described with reference to FIG. 3. It is to be understood that the method 800 may include additional acts not shown and/or may omit some shown acts, and the scope of the present disclosure is not limited in this regard.

At block 810, the third network device 310 receives a Cross Link Interference (CLI) measurement report from a first terminal device configured with a first service. The CLI measure report comprises CLI measurement level.

At block 820, in response to the CLI measurement level being above a first threshold level, the third network device 310 transmits, to at least one second terminal device configured with a second service, a first indication for eliminating CLI by the second terminal device. Priority of the first service is higher than priority of the second service.

In some embodiments, the first indication comprises bit field having DCI format, a first state of a bit in the bit field indicates a time unit on which an Uplink (UL) transmission is to be disabled.

In some embodiments, the first indication comprises a time pattern, and wherein the time pattern comprises a first part indicating an Uplink (UL) transmission to be postponed.

In some embodiments, the first indication comprises a time pattern, and wherein the time pattern comprises a second part indicating an Uplink (UL) transmission on which a frequency offset to be performed.

In some embodiments, further comprising: transmitting, to the at least one second terminal device, a sensing configuration indicating the at least one terminal device to perform a sensing procedure before a UL transmission.

In some embodiments, transmitting the first indication comprises: transmitting the third indication in a first group common Downlink Control Information (DCI) signaling.

FIG. 9 illustrates a flowchart of a method 900 of communication implemented at a second terminal device in accordance with some embodiments of the present disclosure. The method 900 can be implemented at the second terminal device 320 shown in FIG. 3. For the purpose of discussion, the method 900 will be described with reference to FIG. 3. It is to be understood that the method 900 may include additional acts not shown and/or may omit some shown acts, and the scope of the present disclosure is not limited in this regard.

At block 910, the second terminal device 320 transmits at least one Cross Link Interference (CLI)-Reference Signal (RS).

At block 920, the second terminal device 320 receives, from a third network device 310 operating in a subband full-duplex mode, a first indication for eliminating a CLI by the second terminal device.

In some embodiments, the first indication comprises a bit field having DCI format, a first state of a bit in the bit field indicates a time unit on which an Uplink (UL) transmission is to be disabled.

In some embodiments, the first indication comprises a time pattern, and wherein the time pattern comprises a first part indicating an Uplink (UL) transmission to be postponed.

In some embodiments, the first indication comprises a time pattern, and wherein the time pattern comprises a second part indicating an Uplink (UL) transmission on which a frequency offset to be performed.

In some embodiments, further comprising: receiving, from the third network device, a sensing configuration indicating the at least one terminal device to perform a sensing procedure before a UL transmission; and determining whether a third priority of a UL transmission to be performed is above a priority threshold: in accordance with a determination that the third priority is above the priority threshold, performing the UL transmission without the sensing procedure: or in accordance with a determination that the third priority is not above the priority threshold, performing the sensing procedure before the UL transmission.

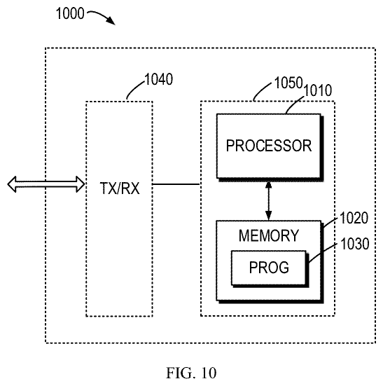

FIG. 10 is a simplified block diagram of a device 1000 that is suitable for implementing some embodiments of the present disclosure. The device 1000 can be considered as a further example embodiment of the terminal devices 130 and 140 as shown in FIG. 1, and the terminal devices 320 and 330 as shown in FIG. 3 or network devices 110, 120 as shown in FIG. 1 and network devices 310 as shown in FIG. 3. Accordingly, the device 1000 can be implemented at or as at least a part of the above network devices or terminal devices.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1020 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between gNBs or eNBs, SI interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1030 is assumed to include program instructions that, when executed by the associated processor 1010, enable the device 1000 to operate in accordance with the embodiments of the present disclosure, as discussed herein with reference to FIGS. 1-9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises circuitry configured to perform method 900.

In some embodiments, a network device comprises circuitry configured to perform method 600, 700 and/or 800.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, technique terminal devices or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 3 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A communication method implemented at a first network device operating in a subband full-duplex mode, comprising:
measuring a Cross Link Interference (CLI) level based on at least one CLI-Reference Signal (RS) received from a second network device;
in response to the measured CLI level being above a first threshold level, transmitting a first indication to the second network device, the first indication comprising service information associated with the CLI.

2. The method of claim 1, wherein the first threshold level is configured for a first service, and wherein the first indication further comprises a CLI elimination request for disabling a Downlink (DL) transmission on a communication resource.

3. The method of claim 2, wherein the CLI elimination request comprises at least one of:
a subband based Time Division Duplex (TDD) configuration of the first network device,
a priority of a service, and
the communication resource.

4. The method of claim 2, wherein the CLI elimination request comprises a set of RSs, wherein each RS of the set of RSs corresponds to a respective service.

5. The method of claim 1, further comprising:
in response to the measured CLI level being above a second threshold level, transitioning from the subband full-duplex mode to a TDD mode.

6. The method of claim 5, wherein the second threshold level is configured for a second service, and the method further comprising:
transmitting, to a terminal device, a second indication indicating that the first network device has transitioned from the subband full-duplex mode to the TDD mode.

7. The method of claim 6, wherein transmitting the second indication comprises at least one of:
transmitting the second indication in a first group common Downlink Control Information (DCI) signaling;
transmitting the second indication in a System Information Block (SIB) signaling; and
transmitting the second indication by a RRC reconfiguration.

8. The method of claim 5, further comprising:
transmitting, to a terminal device, a third indication for postponing Uplink (UL) transmission to be transmitted from the terminal device.

9. A communication method implemented at a second network device, comprising:
transmitting at least one Cross Link Interference (CLI)-Reference Signal (RS) to a first network device operating in a subband full-duplex mode,
receiving a first indication from the first network device, the first indication comprising service information associated with the CLI, and
performing a CLI elimination procedure based on the first indication.

10. The method of claim 9, wherein performing the CLI elimination procedure comprises:
determining the communication resource on which a Downlink (DL) transmission is to be disabled based on the CLI elimination request; and
performing no Downlink (DL) transmission on the determined communication resource.

11. The method of claim 10, wherein determining the communication comprises:
determining the communication resource based on a second TDD configuration of the second device and the subband based TDD configuration in the CLI elimination request.

12. The method of claim 10, wherein performing the CLI elimination procedure comprises:
transmitting, to a terminal device associated with the second network device, a fourth indication indicating to cancel the reception on the communication resource.

13. The method of claim 12, wherein transmitting the fourth indication comprises:
transmitting the fourth indication in at least one of an enhanced DCI format and a second group common Downlink Control Information (DCI) signaling.

14. The method of claim 12, wherein the communication resource is indicated by a bit field having DCI format, a first state of a bit in the bit field indicating a time unit on which the Downlink (DL) transmission is to be disabled.

15. The method of claim 10, wherein performing the CLI elimination procedure comprises:
determining a first priority of a third service affected by the CLI based on the service information associated with the CLI;
determining whether the first priority is higher than a second priority of a fourth service to be performed by the second device; and
in accordance with a determination that the first priority is higher than the second priority, performing an interference cancellation mechanism for the third service; or
in accordance with a determination that the first priority is not higher than the second priority, performing the DL transmission for the fourth service.

16-20. (canceled)

21. A terminal device comprising:
a processor, and
a memory coupled to the processor and storing instructions thereon, the instructions, when executed by the processor, causing the terminal device to:
measure a Cross Link Interference (CLI) level based on at least one CLI-Reference Signal (RS) received from a second network device;
in response to the measured CLI level being above a first threshold level, transmit a first indication to the second network device, the first indication comprising service information associated with the CLI.
